(19) United States
(12) Patent Application Publication
(10) Pub. No.: US 2023/0396138 A1
(43) Pub. Date: Dec. 7, 2023

(54) ELECTRIC DISK MOTOR FOR DRIVING A WHEEL RIM

(71) Applicants: Heinz Georg RUSSWURM, Wien (AT); Oliver KERSCHGENS, Oberndorf (AT)

(72) Inventors: Heinz Georg RUSSWURM, Wien (AT); Oliver KERSCHGENS, Oberndorf (AT); Daniel KERSCHGENS, Wien (AT)

(73) Assignees: Heinz Georg RUSSWURM, Wien (AT); Oliver KERSCHGENS, Oberndorf (AT)

(21) Appl. No.: 18/031,980

(22) PCT Filed: Oct. 13, 2021
(86) PCT No.: PCT/EP2021/078284

§ 371 Date: Apr. 14, 2023

(30) Foreign Application Priority Data
Oct. 15, 2020 (DE) 10 2020 127 172.7

(51) Int. Cl. H02K 16/02; H02K 7/08; H02K 1/278; H02K 5/22; B60K 7/00

(52) U.S. Cl. CPC H02K 16/02; H02K 7/08; H02K 1/278; H02K 5/225; B60K 7/0007; H02K 2201/03; B60K 2007/0061

(57) ABSTRACT

A disk motor includes a stator and a rotor. Electromagnets of the stator are curved and simultaneously act on two permanent magnets of the rotor, which are positioned at an angle to one another. The rotor has a rotor disk, which includes a plurality of permanent magnets. The inner side of a tube section additionally includes a plurality of permanent magnets on the periphery of the rotor disk. This provides a disk motor with internally located rotors and externally located rotors.

### BACKGROUND OF THE INVENTION

Exemplary embodiments of the invention relate to an electric disk motor, which is suitable for an operation directly in a wheel rim of a vehicle.

The increasing e-mobility of society based on electrically operated vehicles—for example in automotive engineering, motorcycle engineering, e-bikes, e-scooters, etc.—is continuously increasing. The demands on the electric drives thus increase as well. To date, the focus was mainly on central electric drives, which act via a gear on one or several axles. These powertrains are based on classic combustion engine-based drive concepts. However, they do not always provide an optimal weight/performance ratio. Electric motors, which are integrated directly on or in individually driven wheels, form the exception to date. This is also due, among other things, to the current construction and the limited efficiency of the used constructions.

For example, the DE 10 2014 111 234 A1 describes a disk rotor motor with at least one stator, which comprises at least one electrical stator winding and stator teeth, which have a tooth neck composed of a soft magnetic powder composite. Furthermore, there is at least one disk-shaped rotor, which comprises permanent magnetic poles formed exclusively by ferrite magnets at least for producing torque. Even though this disk rotor motor comprises a relatively compact construction, it can convince only to a limited extent with regard to the provided torque.

There is thus a need for a compact disk motor, which can develop a higher torque than traditional disk rotor motors.

Exemplary embodiments of the invention are thus directed to a disk motor, which meets the requirements with regard to compactness as well as a high torque.

### BRIEF DESCRIPTION OF THE INVENTION

According to a first aspect, an electric disk motor is introduced, which is suitable for operation in a wheel rim of a vehicle.

The electric disk motor comprises a first rotor and a first stator ring. The first rotor comprises a rotor ring, which, in turn, comprises a first ring-shaped surface and a second ring-shaped surface located parallel on the opposite side, each extending perpendicular to an imaginary axis of rotation, which runs through a center of the rotor ring.

The rotor ring also comprises a first plurality of permanent magnets, which are regularly arranged on a circular path in corresponding circular segments and which extend through the rotor ring from the first surface towards the second surface. A north-south alignment of the permanent magnets of the first plurality thereby runs parallel to the imaginary axis of rotation in each case, and respective adjacent permanent magnets comprise north-south alignments rotated by 180° to each other.

The rotor ring furthermore comprises a first tube section, which extends from an outer periphery of the rotor ring concentrically to the imaginary axis of rotation away from the first ring-shaped surface. The first tube section thereby comprises a second plurality of permanent magnets regularly arranged on an inner side of the first tube section, wherein the first plurality is numerically identical to the second plurality. A north-south alignment of the permanent magnets of the second plurality in each case runs perpendicular to the imaginary axis of rotation, and adjacent permanent magnets of the second plurality each comprise north-south alignments rotated by 180° to one another. Respective different poles of the corresponding permanent magnets of the first plurality and of the second plurality in the respective circular segment are located at a predefined angle to one another. The angle can be 90° or more, e.g., up to approximately 135°.

The electric disk motor furthermore comprises a first stator ring, which comprises a first ring-shaped surface and a second ring-shaped surface located parallel on the opposite side, each extending perpendicular to the imaginary axis of rotation, which runs through a center of the first stator ring and of the rotor. The imaginary axes of rotation of the first stator ring and those of the rotor are identical thereby.

The stator ring furthermore comprises a third plurality of electromagnets within the first stator ring, wherein the third plurality is numerically smaller than the first plurality. The electromagnets comprise a curved core—for example curved by 90° or more. Normal vectors on the poles can comprise an angle to one another, which corresponds to the predefined angle.

One pole of one of the respective electromagnets points towards an outer circumferential periphery of the first stator ring, and a correspondingly other pole of the respective electromagnet is directed towards the first surface of the first stator ring.

In the electric disk motor, a first gap is located between the respective poles of the electromagnets pointing towards the periphery of the stator ring and the second plurality of the permanent magnets on an inner side of the first tube section of the rotor. A second gap is moreover located between the poles of the electromagnets pointing towards the first surface and the first plurality of permanent magnets, which is located opposite a plane of the corresponding poles of the electromagnets. The rotor is thus rotatable freely with respect to the stator ring—for example on an axle. This is also possible elegantly because the vertical and horizontal magnetic currents center and stabilize the rotor. A quiet and stable run is the result.

The introduced disk motor has a number of technical effects and advantages and improvements: Compared to traditional disk rotor motors, which generally comprise horizontally aligned electromagnets in the stator, the efficiency of the disk motor introduced here can be increased significantly by means of the concept, which is introduced here, of the curved cores and windings of the electromagnets of the stator. The reason for this is that even though only one stator and one rotor element are used, an electromagnet of the stator can simultaneously act on two permanent magnets of the rotor, which are arranged at an angle to one another. In principle, a double power density, i.e., torque, which is twice as high, compared to disk rotor motors, which are of identical size and otherwise comparable, can thus be attained. The ratio of the costs of the production compared to the attained torque thus improves as well.

According to another aspect, simpler permanent magnets can be used compared to conventional disk rotor motors, which can optionally also manage without expensive rare earths, but also comprise only a low magnetization. The reason for this is that, compared to conventional concepts, twice the number of magnets is present, and the electromagnets can generate torque simultaneously via their respective north pole as well as via their respective south pole. This can significantly influence the economic efficiency of the introduced disk motor.

The base of the proposed construction also results in further advantages, such as, for example, an efficient cooling by means of the air scoops on inner sides of the rotor—in particular on the first surface of the rotor disk and the inner side of the tube section extending away from the rotor disk and over the stator.

In contrast to conventional disk rotor motors, the concept introduced here is characterized by its improved start-up behavior. The additional alignment of the vertical magnets facilitates the start-up because they are aligned in the direction of rotation. For a good control, conventional disk rotor motors are thus equipped with Hall sensors, which can be forgone here. Hall sensors have a limited service life and can be temperature-sensitive. This problem is reliably bypassed.

The additional magnet alignment also improves a possible recuperation behavior if the disk motor is used as generator during braking processes. Conventional vehicles can moreover be retrofitted with the concept introduced here by means of the introduced construction if a corresponding wheel rim is used as well. Normal vehicles with combustion engine can be converted into hybrid vehicles in this way.

Further exemplary embodiments of the electric disk motor are described below:

According to a further developed exemplary embodiment, the electric disk motor can also have a spacer tube section, which extends concentrically away from the first surface of the stator ring between the electromagnets and an inner diameter of the first stator ring. Moreover, a second stator ring, which is mounted concentrically to the spacer tube section parallel to the first stator ring, can be present. The second stator ring can thereby have a setup corresponding to the first stator ring, and the first surface of the first stator ring can be located opposite the first surface of the second stator ring. The rotor ring can thereby be located between the two first surfaces. The second stator ring would thus be arranged mirror-inverted to the first stator ring.

A second tube section, which extends concentrically and symmetrically to the first tube section from the second surface of the rotor and comprises corresponding permanent magnets, can furthermore be present. Polar alignments of the permanent magnets on the inner side of the first tube section and the inner side of the second tube section can thereby in each case alternate in the same circular segment, i.e., N-S-N-S-N-S- . . . .

A third gap can additionally be present between the respective poles of the electromagnets facing the periphery of the second stator ring and the plurality of the permanent magnets on the inner side of the second tube section of the rotor. Moreover, a fourth gap can be present between the poles of the electromagnets of the second stator ring pointing towards the first surface and the first plurality of permanent magnets located opposite a plane of the poles of the electromagnets of the second stator ring, so that the rotor is rotatably freely with respect to the stator rings.

In this exemplary embodiment, the rotor, which actually comprises a left and a right half, which, however, are firmly connected to one another, can rotate between the two stator elements, which are spaced apart from one another by means of the spacer tube section (internally running rotor).

According to a further exemplary embodiment of the electric disk motor, the latter comprises a first rotary earing on an outer side of the spacer tube section for receiving an inner side of the side of the rotor facing the axis of rotation. A roller bearing—or one or several ball bearings—can be provided at this point, for example, on the spacer tube section, so that the rotor is rotatably mounted on the spacer tube section.

According to an alternative further developed exemplary embodiment of the electric disk motor, the latter can additionally comprise a second stator ring, which has a setup identical to the first stator, wherein the first and the second stator ring are firmly connected to one another via their second surfaces. A connecting ring can thereby be present between both or the two second surfaces are directly connected to one another. Moreover, the two stator rings can also be connected to one another via webs, so that air can flow through between them, which would be good for an additional heat dissipation. However, the two stator rings should generally be arranged mirror-inverted to one another, so that, each directed outwards, the cores of the electromagnets point in the respective first surfaces.

Moreover, this alternative further developed exemplary embodiment can comprise a second rotor, which has a setup identical to the first rotor, wherein a peripheral end of the respective first tube section of the first rotor and of the second rotor are firmly connected to one another, so that a network of the first rotor and the second rotor resulting in this way, enclose the first stator and the second stator in an outer region, in which the two first tube sections are connected to one another and, in the region of the periphery of the stator rings, enclose the latter.

In this case, the stator or the two stator halves, respectively, would be located within the two halves of the rotor, which are firmly connected to one another, however, and thus form a unit (externally running rotor). It shall be assumed thereby that the terms “stator ring” and “stator” can be used synonymously.

According to a supplementary exemplary embodiment of the electric disk motor, the rotor ring can additionally comprise first air scoops on a surface of the rotor ring, which points towards the imaginary center of the rotor ring. They can ensure a good internal ventilation of the electric disk motor and can thus protect it against an overheating.

According to a further supplementary exemplary embodiment of the electric disk motor, the rotor ring can comprise, next to or between the permanent magnets of the first plurality, second air scoops, which extend away from the first surface of the rotor ring within the first gap. They can also ensure an additional good internal ventilation of the electric disk motor, so that as much as possible of the hot air, which can form between the gaps of the disk motor, is conveyed out of the disk motor.

According to a practical exemplary embodiment of the electric disk motor, a second rotary bearing—for example as roller or double ball bearing—can be present on the inner side of the tube section, wherein the second rotary bearing is adapted to receive a hub, which is rotatably mounted in the second rotary bearing. This hub can belong, for example, to a wheel rim of a vehicle. The hub could then be firmly connected to a brake disk present on the vehicle.

According to an advantageous exemplary embodiment of the electric disk motor, the ratio between third plurality and first plurality can be 3 to 4. This would mean that the number of the permanent magnets in the rotor would be higher compared to the number of the electromagnets in the stator. For example, 28 permanent magnets could thus be present in the rotor, while only 21 electromagnets would be present in the stator. This ratio has proven to be useful for the mode of operation of the electric disk motor. However, other plurality ratios are possible as well.

According to a further advantageous exemplary embodiment of the electric disk motor, the first stator ring can comprise—for example on its second surface—electric connections—for example three connections—which can be connected to respective selected ones of the electromagnets via electric connections running within the first stator ring, so that, e.g., each third electromagnet can in each case be activated simultaneously. A known method for the effective electric connection of the electromagnets and a corresponding control among one another can thereby be resorted to.

According to an additional exemplary embodiment of the electric disk motor, the spacer tube section can comprise insulated through-contacts, which selectively connect the electric connections located in the first stator ring and the second stator ring to one another. For this purpose, plug connections, for example, can be provided on the spacer tube section and in the surfaces of the stator rings. Exposed electric cables would not be present within the electric disk motor in this way. Nonetheless, a modular setup would be possible.

According to a practical exemplary embodiment of the electric disk motor, the first and/or the second stator ring can consist of aluminum, steel, plastic including carbon material, or other composite materials, into which the coil (with the cores) of the electromagnets and insulated electric connections can be embedded. For example, the electromagnets could be fixed on one of their sides to a specified surface with their respective cores. The respective supporting material of the respective stator could then be cast around the electromagnets. Moreover, it is possible to produce the supporting parts of the stator and of the rotor using a 3D printing process. In any case, the stator should consist of a material with sufficient quality, in order to be able to withstand the arising forces and to simultaneously be able to dissipate waste heat well. In contrast to this, the rotor parts could be dimensioned to be lightweight because they can be stabilized additionally by means of the wheel rim, which is potentially located around it. However, it is also required in the case of the rotors that the connection to the respective—e.g., adhered or embedded—magnets is stable in order to prevent a detaching of the magnets from the surfaces of the rotors.

According to a further developed exemplary embodiment of the electric disk motor, a fastening element can be present, which extends away from one of the surfaces of the stator ring and the outer bearing point of which on the stator ring should comprise a smaller distance from the axis of rotation than an inner diameter of a rotor ring, and the inner bearing point of which on the stator ring comprises a larger distance from the axis of rotation than the inner diameter of a rotor ring. The fastening element could thus be connected completely to the respective second surface of the stator ring.

Moreover, the fastening element can be designed so that it is suitable to be connected firmly or detachably again to an element of a vehicle—for example the brake caliper. The brake caliper could comprise a corresponding receiving device.

Accordingly, and according to a further advantageous exemplary embodiment of the electric disk motor, the fastening element can be suitable to engage with a groove, a lug, or a bore of a brake caliper, whereby a rotation of the stator or of the stators with respect to the brake caliper is prevented. Alternatively, other elements on a respective axle of a vehicle can also be used to prevent a rotation of the stator during active operation. Moreover, the electric connections could be connected by means of or via the fastening element to corresponding connections on the brake caliper or another connecting point of the respective axle of the vehicle. By means of a guidance of the electric connections within the fastening element, exposed electric cables would also not be present at this point.

By simply inserting or piercing the fastening element into a corresponding groove in the brake caliper, a wheel change can be performed using the conventional method. Moreover, it would be conceivable that the wheel rims were delivered completely with the disk motors. The respective motor would only need to be connected to the vehicle electrics/electronics via a plug.

According to a special exemplary embodiment, the fastening element can extend perpendicularly away from one of the surfaces of the stator ring. Alternatively, fastening elements are also conceivable, which extend away from the surface of the stator ring at predefined angles. “Extending perpendicularly away” does not necessarily mean “parallel to the axis of rotation”. The fastening element should always be designed so that the largest possible torque between the stator and the brake caliper—or of another stationary part of a vehicle can be transmitted. Structural features of the vehicle can also play a role thereby.

According to a practical exemplary embodiment of the electric disk motor, the latter can comprise a third rotary bearing—for example in the form of a roller bearing or double ball bearing—on a side of the first rotor ring facing the axis of rotation, wherein the third rotary bearing is adapted to receive a hub, which is rotatably mounted in the third rotary bearing. The hub can belong, for example, to a wheel rim, which is typically mounted in a screwable manner to an element of a brake disk. A firm connection would thus consist between the wheel rim and the brake disk. The disk motor would be located between the hub and an inner side of the wheel rim part, which receives the tire.

Accordingly, and according to a further exemplary embodiment of the electric disk motor, the hub can thus be the hub of a wheel rim. Alternatively, the hub can be an axially symmetrical extension of a brake disk oriented towards the stator. In both cases, the effect of the drive of the wheel rim can be attained by means of the disk rotor motor.

According to a further practical exemplary embodiment of the electric disk motor, a radial surface of a respective first tube section can comprise one or several grooves or lugs (e.g., parallel to the axis of rotation), which can be adapted to engage with corresponding lugs and grooves of a wheel rim inner side. The disk rotor motor would thus quasi be located within the wheel rim, wherein the wheel rim would be guided with the hub through the center of the disk rotor motor and the outer periphery of the rotor/rotors would engage with corresponding elements (lugs, grooves, etc.) of the wheel rim.

According to a supplementary exemplary embodiment of the electric disk motor, respective cores and/or coils of the respective electromagnets should be flush with the surfaces, to which they are adjacent. It is ensured therewith that parts of the electromagnets do not protrude beyond the surfaces, from which they exit. It becomes possible in this way to ensure the narrowest possible gaps between the moving parts, whereby a high efficiency of the disk motor is attained.

According to a further supplementary exemplary embodiment of the electric disk motor, the fastening element can be adapted to received electric connections of the respective stator and to make them connectable to a vehicle. The electric connections of the electromagnets of the stator/the stators can be guided in the interior of the fastening element. The electric connections can be embodied as plug (or socket) and can be connected via the fastening element into a counterpart on the vehicle (socket/plug)—for example on the brake caliper—for power transmission purposes. The disk motor could thus be withdrawn easily from the wheel rim as well as from the brake disk without a further screw connection after the removal of the wheel rim.

It is pointed out that embodiments of the invention were described with reference to different subject matters of the invention. Some embodiments of the invention can in particular have been described with device claims, and other embodiments of the invention with information relating to the method. When reading this application, however, it will become immediately clear to the person of skill in the art that, unless specified explicitly to the contrary, any combination of features, which belong to different types of subject matters of the invention, is also possible in addition to a combination of features, which belong to one type of a subject matter of the invention.

Further advantages and features of the present invention result from the following exemplary description of currently preferred embodiments. The individual figures of the drawings of this application are to only be considered to be schematic, and not to be to scale.

### BRIEF DESCRIPTION OF THE FIGURES

FIG. 1 illustrates a basic form of the disk motor with a rotor ring and a stator ring, which are separated from one another.

FIG. 2 shows a sectional image through a stator with a curved electromagnet.

FIG. 3 illustrates the assembled disk motor.

FIG. 4 illustrates a half-section through the assembled disk motor according to FIG. 3.

FIG. 5 shows the stator together with a spacer tube section.

FIG. 6 shows a network of the two stators, which are connected to one another by means of the spacer tube section.

FIG. 7 shows the expanded rotor with a second tube section, which extends concentrically and symmetrically to the first tube section from the second surface of the rotor.

FIG. 8 shows an assembled disk motor consisting of the double stator according to FIG. 6 and the rotor according to FIG. 7.

FIG. 9 shows a half-section through stators according to an exemplary embodiment.

FIG. 10 shows two adjacent stators.

FIG. 11 shows a view of an exemplary embodiment with a rotor part of an externally located rotor.

FIG. 12 shows an embodiment of the disk motor with externally located rotor.

FIG. 13 shows a half-section 1300 of the exemplary embodiment of the disk motor with an externally running rotor according to FIG. 12.

FIG. 14 shows an example for air scoops on a rotor inner side.

FIG. 15 shows a detail image for air scoops.

FIG. 16 shows a disk motor, the rotor of which comprises an example for a toothing on its outer side.

FIG. 17 shows the disk motor according to FIG. 16, installed into a wheel rim in half-section illustration.

FIG. 18 shows a disk motor with fastening element and a separate brake caliper/brake disk combination.

FIG. 19 show a fastening element engaged with a brake caliper.

### Detailed Description of Exemplary Embodiments

The following terms and expressions are used in this document:

The term “rotor” describes the rotatable part of an electric motor. In the case of the disk motor introduced here in its basic form, the rotor has essentially the shape of a disk, which is fitted with permanent magnets. On the periphery of the rotor disk, the rotor additionally has an axially symmetrical extension, which extends away from the rotor disk and which can also be fitted with permanent magnets on its inner side.

The term “wheel rim of a vehicle” describes a part of a vehicle carrying a tire, e.g., of a passenger car, a van, or a truck. However, bicycles (e-bikes), e-scooters, or e-motorcycles are conceivable as well. The wheel rim is typically connected to a rotatable part on the vehicle, which is mounted in or on the wheel suspension via the hub of the wheel rim. The disk motor can be located within the wheel rim and can be enclosed by the latter. The inner side of the wheel rim can receive the rotor in it in an accurately fitting manner. A toothing can ensure that a power transmission or torque transmission, respectively, from the disk motor to the wheel rim can take place.

The term “rotor ring” describes the inner part of a rotor of the disk motor. It can have a first and a second surface. Permanent magnets can be embedded into the surface of the rotor ring at regular distances or regular circular segments, respectively. The orientation of the permanent magnets alternates between adjacent permanent magnets.

The term “permanent magnet” describes an element of a ferromagnetic material. The material of the permanent magnets, which are used in the introduced disk motor, should comprise a high permanent magnetization, as it is the case with hard magnetic materials of alloys of iron, cobalt, nickel, ferrites, and other rare earths.

The term “tube section” describes a part of a tube, the sectional areas of which run substantially perpendicular to the longitudinal symmetry of the tube. The length of the tube section can thereby be smaller than its diameter.

The term “stator ring”—stator, in short—describes a basic element of a stator of the disk motor. In contrast to the rotor, the stator is stationary. The stator ring can receive the curved electromagnets, so that poles of the electromagnets face towards the periphery of the stator ring on the one hand and towards a lateral surface or a first surface of the stator ring on the other hand. The material of the stator ring can comprise, e.g., aluminum or an Al-comprising alloy or also carbon composites. The stator ring should also have the ability to dissipate heat. Material combinations are also conceivable, in which the electromagnets are inserted into larger openings of the stator disk and are then cast in by means of a composite.

The term “spacer tube section” describes a tube section, which can be used to space apart two stators or stator disks. It can also comprise bores or threads, by means of which the stator disks can be mounted to the spacer tube section. With the material of the spacer tube section, insulated electrical lines can moreover be guided from one stator disk to the other and can thus selectively connect the electromagnets electrically.

Here, the term “electromagnet” describes an electromagnet, which is geometrically designed in a special way. The core of the electromagnet is thereby not linearly stretched but runs on a curved path, e.g., a quarter circle. Surfaces of the ends of the core of the electromagnet are thus located relative to one another at an angle of, e.g., 90°. Other angles are also possible, e.g., up to approx. 140°. The pole pointing outwards towards the periphery of the stator ring in particular does not need to run parallel to the central axis of the stator ring. In such a case, however, the inner side of the tube section of the rotor should also be tilted with respect to the axis of rotation, so that a largely constant gap results between the pole surface of the electromagnet and the magnets on the inner side of the tube section of the rotor ring. However, only the surfaces of the permanent magnets could be tilted.

With the plurality of the electromagnets, an effective control of the electromagnets is required, in order to drive the rotor of the disk motor in the most effective manner possible. Commercially available controllers can be used for this purpose. They can simultaneously activate several—in particular selected—of the plurality of the electromagnets of the stator ring. The electromagnets are typically electrically connected to one another within the stator ring so that only three external connections are required.

The electromagnets additionally comprise windings, which, however, have to follow the curvature of the curved core.

It is pointed out that features or components, respectively, of different embodiments, which are identical or at least functionally identical with the corresponding features or components, respectively, of the embodiment, are largely provided with identical reference numerals or with another reference numeral, which differs from the reference numeral of a (functionally) corresponding feature or of a (functionally) corresponding component only in its first digit. To avoid unnecessary repetition, features or components, respectively, which have already been described on the basis of an above-described embodiment, will no longer be described in detail at a later point.

It is further pointed out that the embodiments described below only represent a limited selection of possible embodiment alternatives of the invention. It is possible in particular to combine the features of individual embodiments with one another in a suitable way, so that a plurality of different embodiments are to be considered as having been disclosed in an obvious manner for the person of skill in the art by means of the embodiment alternatives, which are illustrated explicitly here.

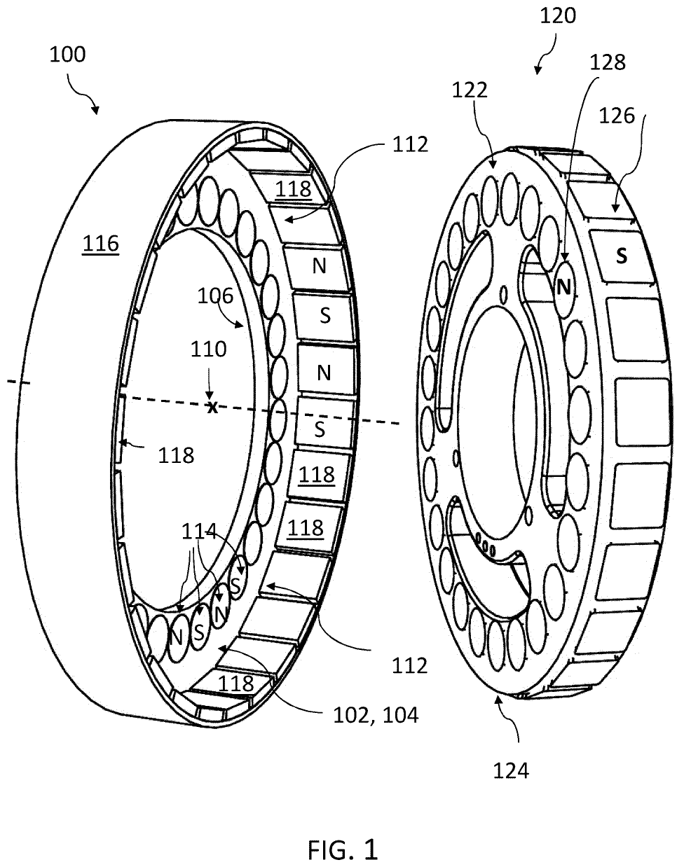

FIG. 1 shows a basic form of the disk motor with a rotor ring 116 and a stator ring 120, which are separated from one another. The rotor ring 102 comprises a first ring-shaped surface 102 and a second ring-shaped surface 106 located parallel on the opposite side, each extending perpendicular to an imaginary axis of rotation through a center 110 of the rotor ring, and a first plurality of permanent magnets 114 (not all permanent magnets are identified by the reference numeral), which are regularly arranged on a circular path in corresponding circular segments and which extend through the rotor ring 102 from the first surface 104 towards the second surface 106. The permanent magnets 114 can reach all the way to the second surface 106 or can also be flush with the latter only on the first surface. A north-south alignment of the permanent magnets 115 of the first plurality thereby runs parallel to the imaginary axis of rotation in each case, and respective adjacent permanent magnets 114 each have north-south alignments rotated by 180° to each other. This means that their north-south direction in each case alternates between adjacent permanent magnets 114.

A first tube section 116, which extends concentrically to the imaginary axis of rotation away from the first ring-shaped surface 102 (in FIG. 1 from left to right) is moreover mounted to the rotor ring 102. The tube section 116 thereby comprises a second plurality of permanent magnets 118, which are regularly arranged on an inner side of the first tube section 116. It shall moreover be pointed out that reference numeral 116 is illustrated on an outer periphery of the tube section 116 and thus of the rotor ring 102.

The first plurality is numerically identical to the second plurality; this means that the number of the permanent magnets 118 on the inner side of the tube section 116 and those in the first surface 104 of the rotor ring 102 are identical and are in each case located in the same circular segment in pairs.

What applies for the permanent magnets 118 is that the north-south alignments of the permanent magnets 118 of the second plurality in each case run perpendicular to the imaginary axis of rotation and adjacent permanent magnets 118 of the second plurality each comprise north-south alignments rotated by 180° to each other. This means that the alignments of adjacent permanent magnets 118 alternate regularly. Different poles of the corresponding permanent magnets 114 of the first plurality and of the second plurality (permanent magnets 118) are moreover each located at an angle of, for example, 90° relative to one another in the respective circular segment.

The disk motor moreover comprises the first stator ring 120. The latter has a first ring-shaped surface 122 and a second ring-shaped surface (not illustrated) located parallel on the opposite side, each extending perpendicular to the imaginary axis of rotation through a center 110 of the first stator ring 120 and of the rotor 100, wherein the imaginary axis of rotation of the first stator ring 120 and that of the rotor 100 are identical.

The stator 120 furthermore comprises a third plurality of electromagnets (not directly visible here because located in the interior of the stator 120) within the first stator ring 120. The third plurality is thereby numerically smaller than the first plurality. This means that the number of the electromagnets in the stator 120 has a smaller number than the number of the permanent magnets in the surface 104 of the rotor ring 102, or on the inner side of the tube section 116, respectively; a ratio of 3:4 thus provided to be practical, for example 21:28. However, other ratios are possible as well.

The electromagnets comprise a curved core (e.g., 90° or also angles down to approx. 45°). One pole 126 of a respective electromagnet points towards an outer circumferential periphery 124 of the first stator ring 120, and a corresponding other pole 128 of the respective electromagnet is aligned towards the first surface of the first stator ring 120.

A first gap is thus located between the respective poles 126 of the electromagnets pointing towards the periphery 124 of the stator ring 120 and the second plurality of the permanent magnets 118 on the inner side of the first tube section 116 of the rotor 110. A second gap is located between the poles of the electromagnets pointing towards the first surface 102 and the first plurality of permanent magnets 114, which is located opposite a plane of the corresponding poles of the electromagnets, so that the rotor 100 is rotatable freely with respect to the stator ring 120.

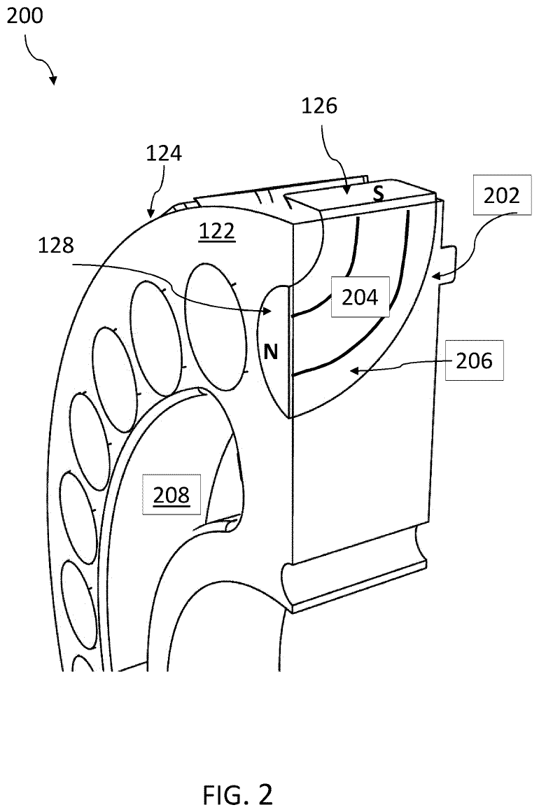

FIG. 2 shows a sectional image 200 through a stator 120 with a curved electromagnet 202. Each of the electromagnets 202 comprises a curved core 204 and a corresponding winding surround it in the usual way. A respective pole 126 of the electromagnets 202 thus points towards the outer periphery 124 of the stator ring 120 and thus towards the permanent magnets 118 of the rotor, when the rotor is pushed over the stator. The other pole 128 of the electromagnets 202 then points towards the permanent magnets 114, which are integrated into the first surface 104 of the rotor ring 102.

The rotor ring can moreover have apertures 208 in some sections. They can ensure an improved internal ventilation of the disk motor and moreover ensure a weight reduction with full functionality.

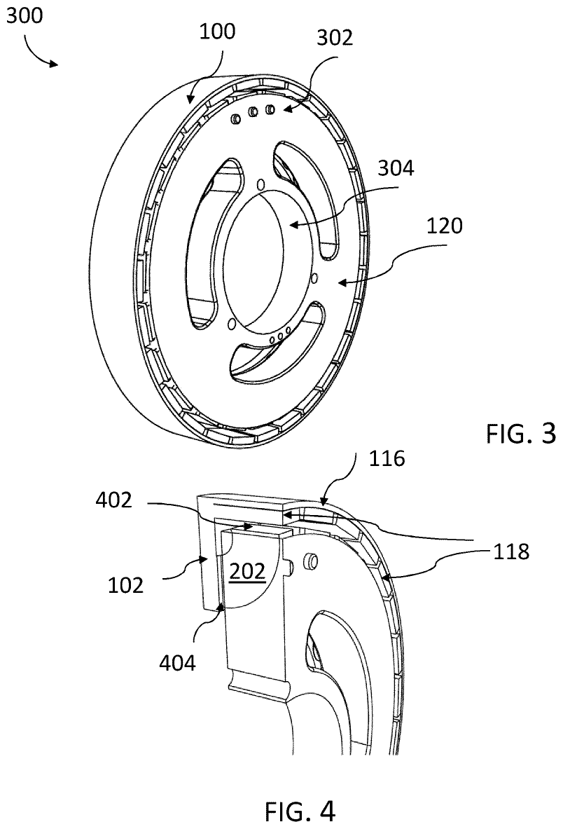

FIG. 3 illustrates the assembled disk motor 300, which consists of the rotor ring 100 and the stator/stator ring 120—as described above. Electric connections 302 can furthermore be seen, which are connected to the electromagnets in the usual way within the stator. The inner periphery 304 of the stator 120 can comprise a bearing (not illustrated), through which a hub can be inserted, which belongs, e.g., to a wheel rim or another axle, which can be driven by means of the rotor ring 100 by means of, e.g., interlocking. A suitable bearing for the rotor 100 is thus unnecessary (weight savings).

FIG. 4 illustrates a half-section 400 through the assembled disk motor 300 according to FIG. 3. The 1st gap 402 between the one pole of the curved electromagnet 202 and the magnets 118 on the inner side of the tube section 116 of the rotor and the 2nd gap 404 between the other pole of the electromagnets 202 and the permanent magnets 114 of the rotor disk 102 can be seen well.

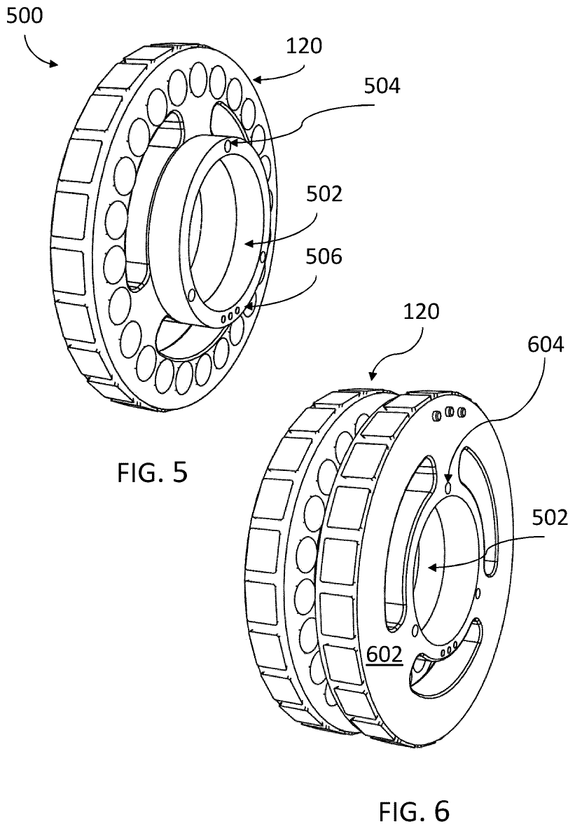

FIG. 5 shows the stator 120 together with a spacer tube section 502, which, concentrically to the central axis of the stator/stator ring 120, is firmly connected to the latter. For this purpose, the stator ring can be connected to threads in the bores 504 of the spacer tube section 502, e.g., through bores through the stator.

FIG. 6 shows a network of the two stators 120 and 602, which are connected to one another by means of the spacer tube section 502. The bore 604 can be used as feedthrough for a screw connection to the spacer tube section 502. The spacer tube section 502 can also receive the electrical lines for the stator 120 in the interior of the spacer tube section 502. Plug connections 506 can connect the respective stator 120, 602 to the lines in the interior of the spacer tube section (e.g., via sockets).

The spacer tube section 502 extends concentrically away from the first surface of the stator ring between the electromagnets and an inner diameter of the first ring 120.

The second stator ring 602 is mounted concentrically to the spacer tube section 502 parallel to the first stator ring 120. The second stator ring 602 comprises a setup corresponding to the first stator ring 120. The first surface of the first stator ring 120 is located opposite the first surface 120 of the second stator ring 602. The rotor ring is thereby located between the two first surfaces of the two stators 102 and 602 (not yet illustrated here).

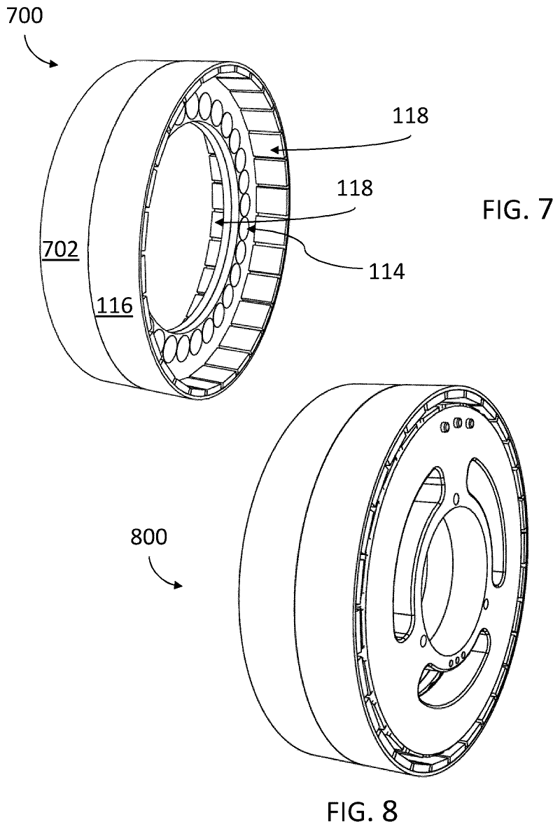

Additionally—in FIG. 7—the now expanded rotor 700 comprises a second tube section 702, which extends concentrically and symmetrically to the first tube section 116 from the second surface 106 of the rotor 100, and corresponding permanent magnets, wherein polar alignments of the permanent magnets on the inner side of the first tube section and the inner side of the second tube section 702 can in each case alternate in the same circular segment.

A third gap is also located here between the respective poles of the electromagnets facing the periphery of the second stator ring and the plurality of the permanent magnets on the inner side of the second tube section of the rotor 100. A fourth gap is located between the poles of the electromagnets of the second stator ring pointing towards the first surface and the first plurality of permanent magnets located opposite a plane of the poles of the electromagnets of the second stator ring, so that the rotor is rotatable freely with respect to the stator ring.

This exemplary embodiment of the rotor is thus set up symmetrically to the rotor disk.

In this exemplary embodiment, the permanent magnets 114 should point from the one surface of the rotor ring to the other one. Corresponding permanent magnets in identical circular segments of the first and of the second tube section of the rotor 100 must moreover have different poles, which each point to the center of the rotor 100. Poles of the permanent magnets (114, see FIG. 1) of the rotor disk and permanent magnets (118, see FIG. 1), which alternate, e.g., at an angle of, e.g., 90° (other angles see above), are thus located opposite one another on inner sides of the respective tube sections on the periphery of the rotor.

It is in fact possible to use two identical rotors 100 according to FIG. 1 with a rotor disk each, as it is illustrated; however, a use of a common rotor disk, through which the permanent magnets 114 reach from one surface 104 (see FIG. 1) of the rotor disk to the other one (106, see FIG. 1), is practical as well.

FIG. 8 shows an assembled disk motor 800 consisting of the double stator 600 according to FIG. 6 in the center and the expanded rotor 700 according to FIG. 7. A assembly of the disk motor 800 results as logical result: (i) providing a stator with a spacer tube section, (ii) attaching the rotor from one side, (iii) attaching the second stator from the same side and connecting the stator to the spacer tube section.

Here, the rotor can also be held by an inner side of a wheel rim, so that the required gaps are adhered to and the rotor remains rotatable freely. The grooves on the periphery of the rotor, which are useful for this purpose, are not illustrated. Alternatively, the rotor can run on a bearing on the spacer tube section

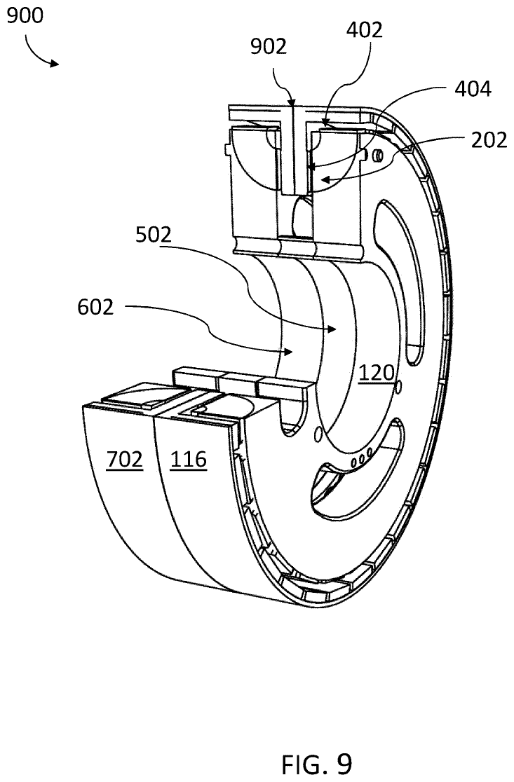

FIG. 9 shows once again a half-section 900 through the stators, the position of the curved electromagnets of the stators 120 and 602, and the two tube sections 116 and 702 of the rotor 100. The rotor of this exemplary embodiment, which could be produced here from two symmetrical partial rotors, each consisting of the rotor ring and the corresponding tube section with the corresponding permanent magnets, can also be made in one piece in its basic structure. It would then consist of a rotor disk and a tube section, which is twice as wide compared to a corresponding tube section and which is firmly connected to the rotor disk in the center. In this case, the center wall 902 illustrated in FIG. 9 between the two partial rotors would be omitted. The thickness of the center wall could be reduced to the thickness of an individual rotor disk in this way. In this case, only half of the permanent magnets in the rotor disk would be necessary for the rotor disk. They would extend from the first surface of the rotor disk to the second surface of the rotor disk. Further cost and weight savings would thus be possible.

It is obvious that this version of the introduced disk motor is referred to as internally running version because the rotor rotates between the two partial stators. It also applies for this that the centering of the rotor can take place via the hub and wheel rim of a wheel.

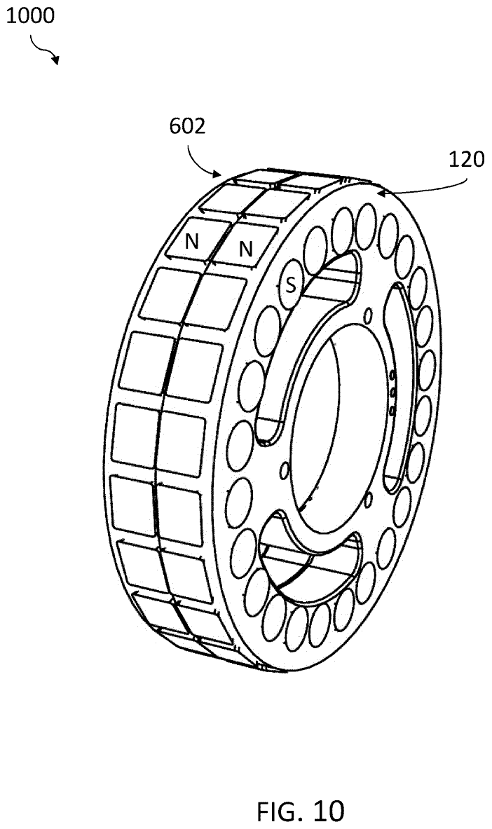

An alternative construction is described by rotor elements located externally, which is illustrated in the following figures. FIG. 10 shows two adjacent stators 120 and 602. The second stator ring 602 has a setup identical to the first stator 120. Both stator parts of the coupled stator 100 are connected to one another via their respective second surfaces. Each of the two stators 120 and 602 has a plurality of curved electromagnets, which exit from the respective circumferential periphery on the one hand and from a respective outer side of the adjacent stators 120 and 602 on the other hand. The poles of the electromagnets, which are located next to one another and which are directed towards the periphery, would typically each comprise the same poles. The electromagnet surfaces, which are identified with “N” and “S” in FIG. 10, represent only a temporary state of two of the electromagnets because they are correspondingly turned on and off according to a predetermined scheme via a respective control circuit, in order to set the respective rotor into rotation by means of the magnetic attraction (or repulsion) between corresponding electromagnets and permanent magnets.

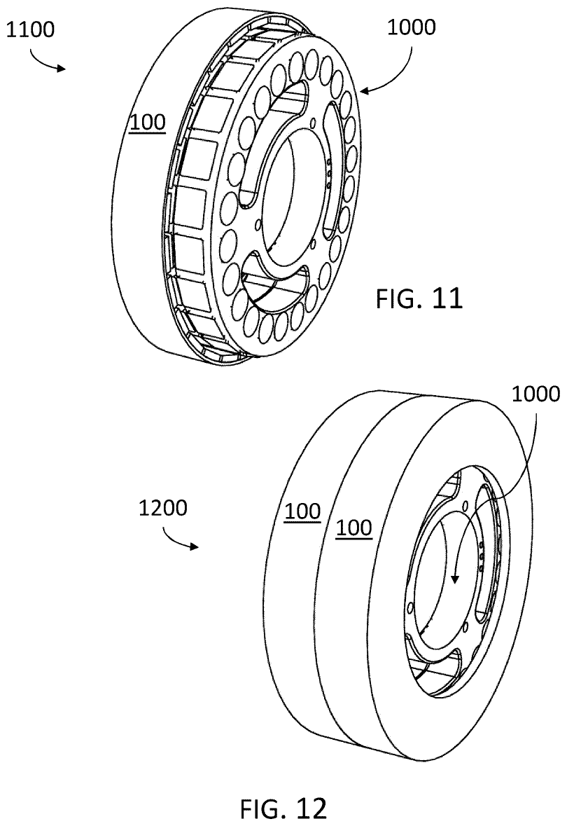

FIG. 11 illustrates a half-section 1100 of an exemplary embodiment with a rotor part 100 of an externally located rotor. The double stator 1000 already introduced in FIG. 10 is half covered in this figure by means of a rotor 100. In FIG. 12, a second rotor part also covers the second stator part of the double stator 1000. The two partial rotors are set up according to FIG. 1 and can be firmly connected to one another. Alternatively, however, they can also be held in a centered manner by means of grooves or toothings running on the periphery by means of the inner side of a wheel rim enclosing them.

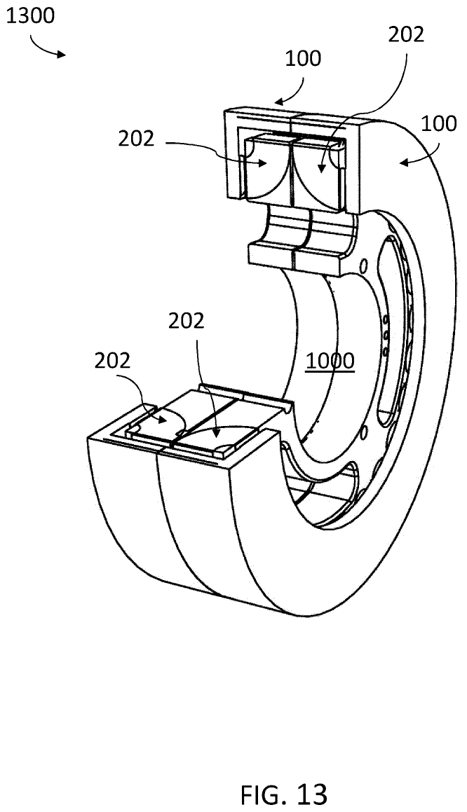

FIG. 13 shows a half-section 1300 through the exemplary embodiment of the disk motor with an externally running rotor consisting of two partial rotors 100. Two of the plurality of the curved electromagnets 202 of the double stator 1000 can also be seen clearly, which each act on a pair of permanent magnets. One of the permanent magnets of the pair is thereby located on one of the rotor disks, and the corresponding other permanent magnet of the pair is located on the respective inner side of the tube section of the respective rotor part.

The rotor parts have an identical (mirror-symmetrical) setup, in the case of which a peripheral end of the respective first tube section of the first rotor and of the second rotor are firmly connected to one another, so that a resulting network of the first rotor and the second rotor enclose the first stator and the second stator in an outer region, in which the two first tube sections are connected to one another, and, in the region of the periphery of the stator ring, enclose the latter.

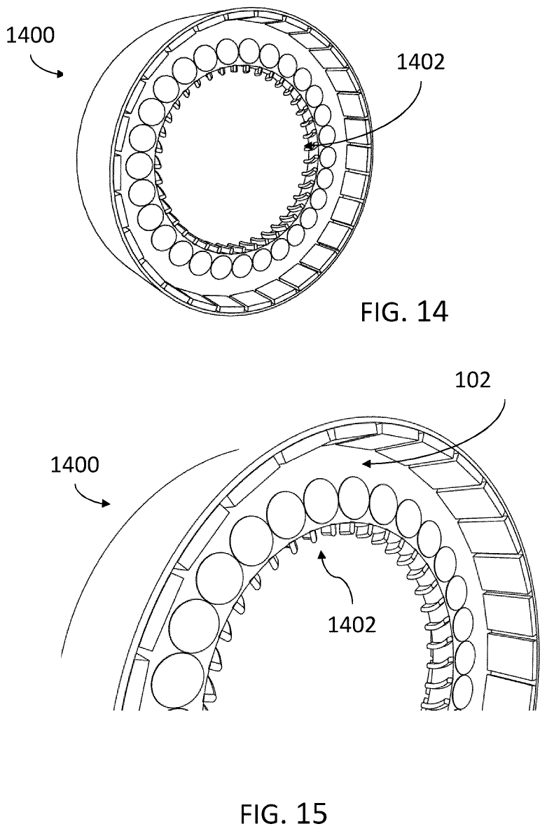

Using the example 1400 and 1500 of the internally running rotor according to, e.g., FIG. 9, FIG. 14, and FIG. 15 show, on the inner side of the rotor, air scoops 1402, by means of which an efficient heat dissipation from the interior of the disk motor can be effected. Air scoops 1400 of this type—as already described above—can also be integrated at other points of the rotor. Examples are the surfaces of the rotor rings 102 or also the inner sides of the tube sections 116 and 702 of the respective rotor. Air scoops could additionally also be attached to the outer periphery of the rotors.

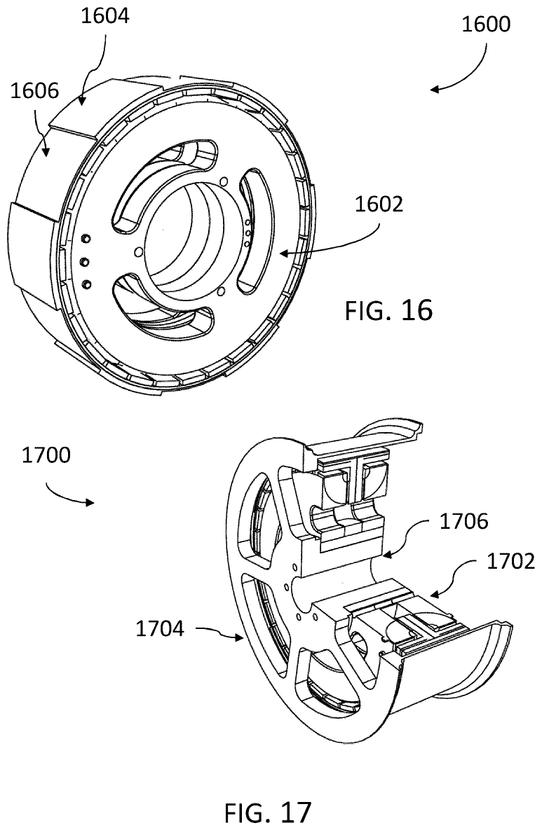

FIG. 16 shows an exemplary embodiment 1600 of a disk motor 1602, the rotor 1608 of which comprises an example for a toothing 1604, 1606 on its outer side. The elevations 1604 and depressions 1606 find their counterparts on an inner side of a wheel rim, so that the rotor 1608 is centered by means of the wheel rim.

FIG. 17 shows an exemplary embodiment 1700 of the disk motor 1702 according to FIG. 16, which is mounted, installed into a wheel rim 1704, in half-section illustration. It can also be seen that the hub 1706 of the wheel rim 1704 receives the disk motor 1702 in that the inner diameter of the stators—or the inner diameter of the disk motor 1702, respectively—corresponds to the hub diameter of the wheel rim 1704, so that the wheel rim can rotate in and around the disk motor 1702. It is not required thereby that the rotor rotates in a separate bearing but is held so as to rotate freely between the stators by means of the wheel rim, with which it is interlocked.

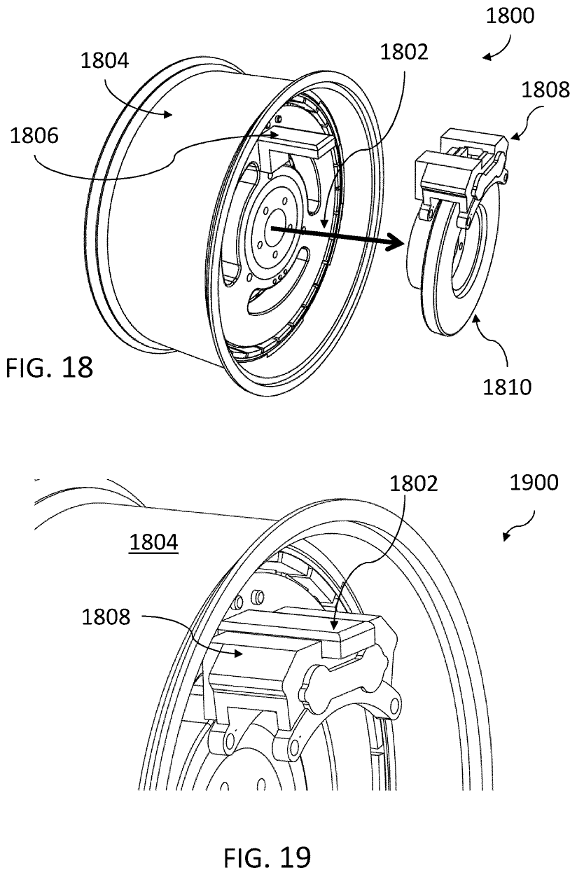

FIG. 18 shows an exemplary embodiment 1800 of the disk motor 1802 with a fastening element 1806 and a separate brake caliper/brake disk combination. The wheel rim 1804, into which the disk motor 1802 is integrated, is illustrated here as well. A brake disk 1810 with a brake caliper 1808 is illustrated symbolically on the right side of FIG. 18. The hub of the wheel rim 1804 can be connected in the usual way to the left part of the brake disk in a screwable manner. The disk motor 1802 can be fixed within the wheel rim in this way. Even though disk motors with internally located rotors have been illustrated in the last exemplary embodiments, disk motors according to the concept introduced here with externally running rotors can be used just as well.

FIG. 19 shows an exemplary embodiment 1900 for a fastening element 1802, which engages with a brake caliper 1808. In this case, the wheel rim 1804—or the hub of the wheel rim, respectively (not illustrated) is fixed to the brake disk (not illustrated). It is clearly visible, however, that the fastening element 1802 engages with a groove of the brake caliper 1808 and the stators are effectively prevented with respect to a rotation on the hub of the wheel rim 1804. Other components of a vehicle could also be used here, alternatively to a use of the brake caliper as counter bearing for the fastening element 1802, which is embodied here as angular fastening element. The disk motor can also be supplied with the necessary electric connections via the fastening element. They can be integrated directly into the fastening element (not illustrated).

The description of the various exemplary embodiments of the present invention was illustrated for a better understanding but does not serve for a direct limitation of the inventive idea to these exemplary embodiments. The person of skill in the art develops further modifications and variations on his own. The terminology used here was selected in order to best describe the basic principles of the exemplary embodiments and to make them easily accessible to the person of skill in the art.

The illustrated structures, materials, processes, and equivalents of all means and/or steps with corresponding functions in the below claims are intended to use all structures, materials, or processes, as expressed by the claims.

In summary, it is important to note: A disk motor is introduced, which, in its basic form, consists of a stator and a rotor. Due to the curved shape of the electromagnets, both poles of which in each case act on permanent magnets of the rotor, a comparatively high torque density and performance can be generated with low costs and a simple setup.

The option of designing the stators and rotors twice in each case results in the options of elegantly realizing a disk motor with an internally running rotor and an externally running rotor.

### LIST OF REFERENCE NUMERALS

100 rotor
102 rotor ring
104 first ring-shaped surface of the rotor ring
106 second ring-shaped surface of the rotor ring
108 imaginary axis of rotation
110 center
112 first plurality of permanent magnets
114 permanent magnets with alternating north/south/north/south alignment
116 tube section
118 second plurality of permanent magnets
120 stator
122 first ring-shaped surface of the stator
124 outer circumferential periphery of the stator
126 pole of an electromagnet of the third plurality
128 other pole of the electromagnet of the third plurality
200 perspective half-section of the stator
202 curved core of one of the electromagnets of the third plurality
204 curved core
206 winding
208 aperture
300 assembled disk motor
302 electric connections
304 inner periphery of the stator
400 perspective half-section through the assembled disk motor according to. FIG. 3
402 1st gap
404 2nd gap
500 stator with spacer element
502 spacer tube section
504 bore
600 connected stators
602 second stator
604 bore
700 expanded rotor with second tube section
702 second tube section
800 assembled disk motor consisting of the double stator according to FIG. 6 and the expanded rotor according to FIG. 7
900 perspective half-section through stators
902 center wall between rotor disks
1000 coupled or double stator
1100 double stator with one-sided rotor
1200 disk motor with externally located rotor
1300 half-section through disk motor with externally located rotor
1400 example of an internally running rotor with air scoops
1402 air scoops
1500 example of an internally running rotor with air scoops
1600 exemplary embodiment
1602 disk motors
1604 elevation
1608 depression
1700 exemplary embodiment
1702 disk motors
1704 wheel rim
1706 hub of the wheel rim
1800 exemplary embodiment
1802 disk motor
1804 wheel rim
1806 fastening element
1808 brake caliper
1810 brake disk
1900 exemplary embodiment

1-19. (canceled)

20. An electric disk motor for operation in a wheel rim of a vehicle, the electric disk motor comprising:
a first rotor comprising a rotor ring, which comprises
a first ring-shaped surface;
a second ring-shaped surface located parallel to the first ring-shaped surface on an opposite side of the rotor ring, the first and second ring-shaped surfaces each extending perpendicular to an imaginary axis of rotation through a center of the rotor ring;
a first plurality of permanent magnets regularly arranged on a circular path in corresponding circular segments and extending through the rotor ring from the first ring-shaped surface towards the second ring-shaped surface, wherein north-south alignments of permanent magnets of the first plurality respectively run parallel to the imaginary axis of rotation, and respective ones of adjacent permanent magnets comprise north-south alignments rotated by 180° to each other;
a first tube section extending from an outer periphery of the rotor ring concentrically to the imaginary axis of rotation away from the first ring-shaped surface, the first tube section comprising a second plurality of permanent magnets regularly arranged on an inner side of the first tube section,
wherein the first plurality of permanent magnets is numerically identical to the second plurality of permanent magnets,
wherein north-south alignments of permanent magnets of the second plurality respectively run perpendicular to the imaginary axis of rotation, and adjacent ones of the permanent magnets of the second plurality each comprise north-south alignments rotated by 180° to one another, and
wherein respective different poles of the corresponding permanent magnets of the first plurality of permanent magnets and of the second plurality of permanent magnets in the respective circular segment are located at a predefined angle to one another,
a stator comprising a first stator ring, which comprises
a first ring-shaped surface;
a second ring-shaped surface located parallel to the first ring-shaped surface on an opposite side of the first stator ring, the first and second ring-shaped surfaces each extending perpendicular to the imaginary axis of rotation through a center of the first stator ring and of the first rotor, wherein the imaginary axes of rotation of the first stator ring and the first rotor are identical;
a third plurality of electromagnets within the first stator ring,
wherein the third plurality of electromagnets magnets is numerically smaller than the first plurality of permanent magnets,
wherein electromagnets of the third plurality of electromagnets each comprise a separate curved core, and
wherein one pole of one of the respective electromagnets of the third plurality of electromagnets points towards an outer circumferential periphery of the first stator ring, and a correspondingly other pole of the respective one of the electromagnets of the third plurality of electromagnets,
wherein a first gap is located between respective poles of the electromagnets of the third plurality of electromagnets pointing towards the periphery of the stator ring and the second plurality of the permanent magnets on the inner side of the first tube section of the first rotor, and
wherein a second gap is located between the poles of the electromagnets of the third plurality of electromagnets pointing towards the first surface and the first plurality of permanent magnets, wherein the second gap is located opposite a plane of the corresponding poles of the electromagnets, so that the rotor is rotatable freely with respect to the stator ring.

21. The disk motor of claim 20, further comprising:
a spacer tube section extending concentrically away from the first ring-shaped surface of the first stator ring between the electromagnets of the first stator ring and an inner diameter of the first stator ring;
a second stator ring, which is mounted concentrically to the spacer tube section parallel to the first stator ring, wherein the second stator ring has a same configuration as the first stator ring, wherein the first ring-shaped surface of the first stator ring is located opposite a first ring-shaped surface of the second stator ring, wherein the rotor ring is located between the first ring-shaped surfaces of the first and second stator rings; and
a second tube section extending concentrically and symmetrically to the first tube section from the second ring-shaped surface of the first rotor and comprising corresponding permanent magnets,
wherein polar alignments of the permanent magnets on the inner side of the first tube section and an inner side of the second tube section, in each case, alternate in a same circular segment,
wherein a third gap is located between respective poles of the electromagnets facing the periphery of the second stator ring and the plurality of the permanent magnets on the inner side of the second tube section of the rotor, and
wherein a fourth gap is located between poles of the electromagnets of the second stator ring pointing towards the first ring-shaped surface and the first plurality of permanent magnets located opposite a plane of the poles of the electromagnets of the second stator ring such that the first rotor is rotatably freely with respect to the first and second stator rings.

22. The disk motor of claim 21, further comprising:
a first rotary bearing on the outer side of the spacer tube section and configured to receive an inner side of a side of the first rotor facing the axis of rotation.

23. The disk motor of claim 20, further comprising:
a second stator ring, which is configured identical to the first stator ring, wherein the first and the second stator rings are firmly connected to one another via their second surfaces,
a second rotor, which is configured identical to the first rotor, wherein a peripheral end of the respective first tube section of the first rotor and of the second rotor are firmly connected to one another such that a resulting network of the first rotor and the second rotor enclose the first stator and the second stator in an outer region, in which the two first tube sections of the first and second rotors are connected to one another and, in a region of a periphery of the first and second stator rings, enclose the latter.

24. The disk motor of claim 20, wherein the first rotor ring additionally comprises first air scoops on a surface of the first rotor ring, wherein the first air scoops point towards an imaginary center of the first rotor ring.

25. The disk motor of claim 20, wherein the first rotor ring comprises, next to or between the permanent magnets of the first plurality of permanent magnets, second air scoops, which extend away from the first ring-shaped surface of the first rotor ring within the first gap.

26. The disk motor of claim 20, further comprising:
a second rotary bearing on the inner side of the first tube section, wherein the second rotary bearing is configured to receive a hub, which is rotatably mounted in the second rotary bearing.

27. The disk motor of claim 20, wherein a ratio between a number of magnets of the third plurality of electromagnets and the first plurality of permanent magnets is 3 to 4.

28. The disk motor of claim 21, wherein the first stator ring comprises electric connections, which are connected to respective selected ones of the electromagnets of the third plurality of electromagnets via electric connections running within the first stator ring such that each electromagnet of the third plurality of electromagnets are simultaneously activatable.

29. The disk motor of claim 28, wherein the spacer tube section comprises insulated through-contacts, which selectively connect the electric connections located in the first stator ring and the second stator ring to one another.

30. The disk motor of claim 21, wherein the first or the second stator ring consists of aluminum, steel, or carbon material, into which coils of the electromagnets of the third plurality of electromagnets and insulated electric connections are embeddable.

31. The disk motor of claim 20, further comprising:
a fastening element extending away from one of the first and second ring-shaped surfaces of the first stator ring,
wherein an outer bearing point of the fastening element on the first stator ring comprises a smaller distance from the axis of rotation than an inner diameter of a first rotor ring, and an inner bearing point of the fastening element on the first stator ring comprises a larger distance from the axis of rotation than an inner diameter of the first rotor ring,
wherein the fastening element is connectable firmly or detachably to an element of a vehicle.

32. The disk motor of claim 31, wherein the fastening element is configured to engage with a groove, lug, or a bore of a brake caliper to prevent a rotation of the stator with respect to the brake caliper.

33. The disk motor of claim 32, wherein the fastening element extends perpendicularly away from one of the first and second ring-shaped surfaces of the first stator ring.

34. The disk motor of claim 20, further comprising:
a third rotary bearing on a side of the first rotor ring facing the imaginary axis of rotation, wherein the third rotary bearing is configured to receive a hub, which is rotatably mounted in the third rotary bearing.

35. The disk motor of claim 34, wherein the hub is a hub of a wheel rim or wherein the hub is an axially symmetrically extension of a brake disk oriented towards the stator.

36. The disk motor of claim 20, wherein a radial surface of the first tube section comprises one or several grooves or lugs, which are configured to engage with corresponding lugs and grooves of a wheel rim inner side.

37. The disk motor of claim 20, wherein respective cores or coils of the electromagnets of the third plurality of electromagnets do not rise with respect to surfaces on which the electromagnets of the third plurality of electromagnets adjoin.

38. The disk motor of claim 31, wherein the fastening element is configured to receive electric connections of the stator and to make the electrical connections connectable to a vehicle.
